(19) United States
(12) Patent Application Publication
(10) Pub. No.: US 2004/0087213 A1
(43) Pub. Date: May 6, 2004

(54) PLUG USED FOR CONNECTION WITH A USB RECEPTACLE

(76) Inventor: CHI-LEI KAO, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,873

(22) Filed: Feb. 26, 2003

Related U.S. Application Data
(63) Continuation-in-part of application No. 10/065,563, filed on Oct. 30, 2002.

(51) Int. Cl. H01R 27/02

(52) U.S. Cl. 439/638

(57) ABSTRACT

A plug used for connection with a USB receptacle. The plug contains a plurality of metal contacts, which is used for contacting metal contacts of the USB receptacle when the plug is connected to the USB receptacle. It also contains a loader, which is used for loading the metal contacts of the plug. The plug has a thickness that is smaller than an ordinary USB plug, so it can be utilized by electronics that have a thickness less than an ordinary USB plug.

### CROSS REFERENCE TO RELATED APPLICATIONS

This application is a continuation-in-part of prior U.S. application Ser. No. 10/065,563, filed on Oct. 30, 2002

### BACKGROUND OF INVENTION

1. Field of Invention

The present invention relates to a connection plug. More particularly, the present invention relates to a plug, which can be connected to a receptacle of universal series Bus (USB) receptacle or a USB plug.

2. Description of Related Art

As the semiconductor fabrication technology has been developed day by day, the functional of the computer is much powerful and is much better than the first computer, which had ever been made. The operation speed and the storage capacity have been tremendously improved but the computer volume has been reduced a lot. When the semiconductor fabrication technology has been extremely developed and the network technology has been developed being popular, the current computer has been not only the definition of computer in the early stage. The compute now can be connected with the other computer in any place of the world via the network, so as to transmit and receive any type of information. Also and, the current computer can process a large amount of multiple media information. In order to conveniently transmit, receive and store various kinds of information, the peripheral devices of the computer system have enormous varieties. In inputting devices includes, for example, keyboard, mouse, scanner, or digital camera, and the outputting devices includes, for example, displaying device, printer, or other kinds of storage devices. New devices are continuously developed, according to the needs from the user. In order to allow these kinds of peripheral devices to communicate with computer, various kinds of input/output (I/O) interface standard have been proposed, in which some of the most common standards are the universal series Bus (USB) standard and the IEEE 1394 communication standard. The USB standard defines transmitting format and speed of information when the USB peripheral device is transmitting information with the computer each other. In addition, the appearance and specification for the plug, receptacle, and the cable connected between, which have been implemented on the peripheral device and the computer, have also been defined, and the same in the IEEE 1394 standard. In the USB standard, it includes the specification for the plug and the receptacle with respect to the series A, series B, series Mini-A, series Mini-B, and so on. Wherein, the USB series A, series Mini-A, and series Mini-B, IEEE 1394a and IEEE 1394b are designed to arrange a set of metal connection terminals of the plug to be disposed on a plane of a holder. Also and, the USB series B is designed to arrange a set of metal connection terminals to be disposed on the upper and lower planes of a holder. For a electronic device using the USB as the I/O interface standard, various kinds of storage devices have been well noted, such as the USB silicon disk. This kind of portable storage device has the advantages that the volume is smaller than that of the conventional portable storage devices, such as the floppy disk. Therefore, it is very convenient for carriage. However, the space for storage device is much greater than the amount for the conventional portable storage device. Furthermore, the capability of plug-and-play has been included between the USB and the computer, so that it has the advantages to avoid the extra connection device and reduce the tedious operation processes in use.

Referring to FIGS. 1-6, FIG. 1 and FIG. 2 are the drawing, schematically illustrating the conventional connection structure for the plug 10 and the receptacle 20 for the USB series A. FIG. 3 and FIG. 4 are the drawing, schematically illustrating the conventional connection structure for the plug 100 and the receptacle 110 for the USB series Mini-A. FIG. 5 and FIG. 6 are the drawing, schematically illustrating the conventional connection structure for the plug 30 and the receptacle 40 for the USB series Mini-B. In FIG. 1, the plug 10 includes a number of metal connection terminals 12, used to connect to the metal connection terminals 22 on the first holder 24, which is implemented in the receptacle 20, when the plug is connected to the receptacle 20 as shown in FIG. 1. A second holder 14 is used to hold the metal connection terminals 12. A metal frame 16 is used to fit into an outer frame 26 of the receptacle 20 when the plug 10 is connected to receptacle 20, in which the four elastic plates 28 arranged in up side and the down side on the outer frame 26 can elastically contact to the metal frame 16, so as to affix the plug 10. In FIG. 3, the plug 100 includes a number of metal connection terminals 102, used to connect to the metal connection terminals 112 on the first holder 114, which is implemented in the receptacle 110, when the plug 100 is connected to the receptacle 110 as shown in FIG. 4. A second holder 104 is used to hold the metal connection terminals 102. A metal frame 106 is used to fit into an outer frame 116 of the receptacle 110 when the plug 100 is connected to receptacle 110, in which the three elastic plates 118 on the outer frame 116 can elastically contact to the metal frame 106, so as to affix the plug 100. Likewise, the plug 30 in FIG. 5 includes a number of metal connection terminal 32, used to connect to a number of connection terminals 42 implemented on a first holder 44 in the receptacle 40, when the plug 30 is connected to the receptacle 40 as shown in FIG. 6. A second holder 34 is used to hold the metal connection terminals 32. A metal frame 36 is used to fit into an outer frame 46 of the receptacle 40 when the plug 30 is connected to receptacle 40, in which the three elastic plates 48 on the outer frame 46 can elastically contact to the metal frame 36, so as to affix the plug 30. However, in order to have the affixing function, the metal frame 16 is used to accept the first holder 24 when the plug 10 is connected to the receptacle 20, in which a second space 16a exits between the metal frame 16 and the second holder 14. The second space 16a determines the thickness of the metal frame 16 as well as the thickness of the plug 10. In order to have the affixing function, the metal frame 106 is used to accept the first holder 114 when the plug 100 is connected to the receptacle 110, in which a second space 106a exits between the metal frame 106 and the second holder 104. The second space 106a determines the thickness of the metal frame 106 as well as therefore the thickness of the plug 100. Likewise, in order to have the affixing function, the metal frame 36 is used to accept the first holder 44 when the plug 30 is connected to the receptacle 40, in which a second space 36a exits between the metal frame 36 and the second holder 34. The second space 36a determines the thickness of the metal frame 36 as well as therefore the thickness of the plug 30. Therefore, when a designer for the peripheral device of the computer system intends to reduce the peripheral device, which uses the USB as the I/O interface standard, the designer will be limited by the thickness of the plug 10, 100 and 30 and cannot design a peripheral device with a thinner appearance than the thickness of the plugs 10, 100, or 30.

For example, the USB silicon disk in the current market, the appearance is always designed to be a thin rectangular volume with a limitation of thickness by the thickness from the plug 10, 100 and 30 without being further reduced in thickness. Also and, the current memory card device usually has its standard size specification, such as, the IC card, which is usually used as the telephone card, the SIM card in cellular phone, as well as the IC credit card, and the compact flash (CF) card and the secure digital (SD) card used in digital camera as the storage unit, the memory stick card, the multi medial card, the smart media card, the MG memory stick card, the XD picture card, the memory stick duo card, the Microdrive card, the memory stick pro card, and so on. Due to the foregoing reasons, those cards should need an extra access apparatus with a cable connection and cannot be directly connected to the computer system via the USB series A receptacle for communication.

Also and, the CF card has the thickness of 0.33 cm but the USB plug, such as the series A, is thicker, such as 0.45 cm. If the thickness of the CF card is changed to 0.45 cm then it cannot be plugged into the CF slot of the digital camera. The computer uses the USB interface with the USB series A receptacle. In this situation, the CF card with the thickness of 0.33 cm cannot be installed with the convenient USB series A plug for directly connecting to the computer USB series A receptacle and providing a convenient way in data transmission. Thus, it needs a CF card reader to read data from CF card and through reader convenient USB series A plug for directly connecting to the computer USB series A receptacle. A USB “mini” type connector can be put in a CF card, but still needs a USB cable with “Mini” to “A” connector convert function. Otherwise it still can”t directly connect a CF card into a computer common USB series A receptacle.

The foregoing conventional issues are also existing in IEEE 1394. For example, FIG. 19 is a drawing of front view, schematically illustrating the connector IEEE 1394a. The conventional IEEE 1394a has a metal outer frame 190, a holder 192, and connecting pins 194 associating with the contacts 196. The thickness of the metal frame 190 for IEEE 1394 still remains large for a memory card.

In addition, the thickness of a MS card (memory stick memory card) is 0.28 cm but the thickness for the conventional standard of USB mini A and mini B plugs is 0.3 cm and the thickness for USB mini A, mini B, and mini AB receptacle is 0.4 cm. If the thickness of the MS card is changed to 0.4 cm, then it cannot be plugged into, for example, the MS slot on a digital camera. However, the MS card with thickness of 0.28 cm cannot be connected to the USB mini A and mini B plugs or the USB mini A, mini B, and mini AB receptacle, which have been widely used, and then is connected to the USB port for a convenient data transmission.

### SUMMARY OF INVENTION

In the invention, a user can directly connect an additional connector of a CF card or a memory card to a USB series A receptacle. Further in the invention, the portable information storage device, which is connected to the peripheral device, can use the USB to connect to the computer, so that the use is more convenient.

The present invention provides a USB connector, which has different appearance from the conventional appearance but can be connected to a plug or a receptacle of the USB series A, series Mini-A, series Mini-B, series Mini-AB, so that the conventional issue about the over large thickness of the USB connector can be solved.

The invention has an objective to provide a USB plug and receptacle and an IEEE 1394a or 1394b connector, which has different appearance from the conventional appearance and is exposed from top side view, and like a connection terminals.

The invention provides a plug, which is used to connect to a USB receptacle or a USB plug. The receptacle has an outer frame, a plurality of elastic member disposed on the inner side of the outer frame, and a first holder having a plurality of metal connection terminals. The plug includes a plurality of metal connection terminals, used to connect to the metal connection terminals of the receptacle when the plug is electrically connected to the receptacle. A second holder is used to hold the metal connection terminals of the plug. The USB plug has an outer frame and a first holder on which a plurality of metal connection terminals have been disposed.

The invention is a design which is different from the conventional design of the USB connector implemented with the metal frame by an over large thickness or a holder with over large thickness, so that the issue of over thickness of the USB connector can be solved.

The present invention uses an independent memory card associating with a master transfer card, which can be individually dismounted with the master transfer card. The master transfer card, for example, is a memory stick transfer card, optionally with a controller to transfer the memory stick connector 7 pins signals to USB interface A. The independent memory card can be mounted or dismounted with the master transfer card, and connect to the USB interface A. A connection member can be optionally included when the independent memory card is combined with the master transfer card, wherein the connection member has a similar outer appearance to one of different type memory cards, so that the master transfer card combined with the independent memory card can be plugged into the slot of one of the memory cards in different type. Also and, optionally master transfer card with one of the different memory card connector is able to connect the connector in one of the different memory card slots. Also and optionally, the independent memory card can be mounted or dismounted from an inner part of the master transfer card.

The present invention can also be applied to the design of the Mini IEEE 1394 connector, which conventionally has a metal frame, causing an over large thickness for memory card. As a result, the thickness of the conventional Mini IEEE 1394 can be reduced.

The objective of the invention includes providing a connection apparatus, which has an architecture of at least dual connector, allowing an inner-disposition single information storage card to be connected, wherein the single storage memory card has at least one or two different connectors, and with one connector for USB or IEEE 1394 interface. The dual connector can also connect with the single information storage card with one or two connector. It also can have a detection function to select the proper data transmission protocol associating with the corresponding at least one connector, so as to communicate with a memory card for accessing the data. As a result, the number of slots for adapting multiple memory cards can be reduced and the volume is therefore reduced. This is convenient for design in adapting the storage memory card with at least two different connectors or one connector. It is also convenient to be connected to the computer USB for data access. And multiple memory cards with different connectors can have the outer mechanical, which is able to insert to a same slot. It can be done that the out appearance for the multiple memory cards is about a square periphery with similar width and thickness. However, this condition is an optional condition. The thickness and the width can be varied according to the actual design.

One of the objectives in the invention is to provide a memory card slot connection device with at least dual connectors, so as to connect to the connector of a single information storage card with at least two different connectors or one connector.

One of the objectives in the invention is to provide a connector of an inner device of an electronic apparatus, such as a computer peripheral apparatus. The connector can be implemented on an insert portable memory device, or on an inner part of a computer or an electronic apparatus to transfer data with USB mass storage protocol. The portable memory device is inserted to a computer, and the computer uses the same USB mass storage protocol to transfer data to portable memory device, which can be dismounted and is connected to the USB connector of the computer in convenience. Also and, the portable memory device can be designed to be separated into two parts, so that when they are put together, it is suitable to insert into a slot. The separated part can include the memory card and a controller and has a connector to connect a device USB port. The function is like a USB silicon disk, but the size is small and long and thin for easy insert, so as to avoid the problem caused by too large area size. For example, for a CF card with a mini USB connector, the insertion of the CF card may touch the cables nearby, and against connector insertion to a USB port action, a CF card with rotate out connector, will support a long thin connector too.

The invention provides an electronic apparatus. The electronic apparatus includes an I/O port A and a control unit. The control unit has a function capable of detecting and selecting a proper one of various data transmission protocols, used to transmit data between a memory card being connected to the I/O port A and the electronic apparatus. Wherein, the memory card may be in different data transmission protocol but the connector of the memory card can be adapted by the I/O port A. For example, the selected one from various data transmission protocols is the USB protocol, and the I/O port A has 9 pins for SD card signals interface, but 4 of 9 pins are also used as the signal pins for connecting to the memory card using the USB protocol for data transmission.

The present invention provides a connection structure between an electronic apparatus and a memory card with USB interface, wherein the connection structure is implemented in the electronic apparatus. The connection structure includes a USB connector and a leading member. The leading member is used to lead the memory card with the USB for mounting and connection. The memory card with USB interface can be inserted inside of the electronic apparatus and is connected with a connector in USB interface for data transmission. The memory card with the USB interface has a structure member, which can be led by the leading member, so as to disposing the memory card with USB interface. The memory card with USB interface can optionally have an outer appearance, which inserted into one of various types of memory card inserted slots. In addition to the like appearance, optionally, it can also include signal connection terminals of the USB interface to connect to the original connector, which is with respect to one of various types of memory cards being inserted to the slot.

The invention provides a connection structure for coupling an electronic apparatus with a memory card with IEEE interface. The connection structure is installed inside the electronic apparatus and includes an IEEE 1394 connector and a structure member. The structure member is used to lead the memory card with IEEE interface for connection and installation. Wherein, the memory card with IEEE interface can be disposed inside of the electronic apparatus to connect to a connector of IEEE 1394 interface for data transmission. Also and, a memory card with IEEE interface has a structure member, which can be led by the structure member of the connection structure, so that the memory card is connected to the connection structure for connecting to a connector of a USB interface.

The invention also provides a memory card device, which includes a memory part, a control device, and an I/O port, wherein an interface of the I/O port is an IEEE 1394 interface. A plurality of exposed connection terminals. The exposed connection terminals are disposed on the memory card. The I/O port of the memory card device can be connected to an electronic apparatus, which adapts the memory card device, for data transmission.

The invention also introduces a memory card with at least 25 exposed connection terminals put at one side, and with interface signals as part of CF or PCMCIA card interface signals, including Vcc, Gnd 11 address signals and at least 8 data signals and read and write control signals. So, a Digital Camera Controller, which with CF or PCMCIA card interface controller can interface with the card inserted. The memory card can be a choice like the PCMCIA card with 68 connection terminals, but it can be with less than 50 exposed connection terminals. Since it is not a standard CF card, it it not necessary to be the CF card big 50 pins connectors. The card size is less than a CF card, and the card can optionally be with an outer appearance, which is similar to one of different types of a memory card, example: SD or others memory cards, so it is able to insert to one of SD or MS or MS PRO or XD or other memory card slot, and connect to another connector, which with at least 25 CF interface connection terminals in the slot, if reduce the CF interface card connection terminals, a CF interface card may be can connect to a SD or, MS or MS PRO or XD slot and connect to 9 or 10 pins connector inside, so the connection slot can with only one connector, but can be share able to connect two types of inserted memory cards, a detect function is need to decide using which types of interface signals for communication, example: detect insert is a SD or a CF interface card, which is connected to SD slot 9 pins connector.

The invention also introduced a transfer controller, having a functional circuit to reduce the memory card CF interface signals number. The transfer controller can be designed to compress at least two of CF card interface signals into one compressed CF interface signal, example: put A0 and D0 signals to only one A0/D0 signal, then it only needs one connection terminal and saves one. This can be done by a connection terminal outputting AO at one time period, and outputting D0at another time period. Also and, it can optionally uses the higher speed one to transmit A0/D0. In this manner, the CF card interface signal number is reduced, and the connection terminal need in the CF interface memory card is reduced and same situation is in the connector of a slot. The card data transmit rate can almost keep same or just little slower. For example, a design is a digital camera controller with support both SD and CF interface, and SD interface signals and CF signals are connected to the transfer controller, and the transfer controller provides at least two interface signals, SD and Mini CF, but those signals are mixed together, and connect to only one 9 pins SD connector in the slot, and with a detect function to select one interface. So, in stead of original case, one uses CF card or SD card for this camera with two slots. Now, one inserts two types of a memory card, SD and Mini CF card, which with similar width and/or similar thickness, and each with one connector, and these two types of memory cards can be inserted to a SD slot and connected to the same 9 pins connector inside. The number of the pins of the two cards needs not to be the same. Alternatively, about the transfer controller, for example, a digital camera controller chip only with one CF interface, and can only use big CF card, and is added with a transfer controller, which is able to transfer CF interface to at least one of MS or DS or compressed CF interface or other types memory card interface signals, and optionally those transferred signals can be mixed together. So, now the camera can have the choice not only using big CF card, but also choosing a SD slot with 9 pins connector, or MS slot with 10 pins connector, or just only one SD or MS slot. In this situation, one can insert CF, DS, MS, or compressed CF card into the digital camera. The same arrangement can be done in only SD interface camera, to support both SD card and compressed CF card to insert into one slot and connect to same SD connector. Also and, the same designs about transfer function can be done in camera with other types of memory card.

Alternatively, the invention can be used for two cards with different length but similar width and similar thickness, and be able to be inserted to the same slot, which with two connectors. It is important that the connectors will not against the longer length card movement (see application 8, connector 50 connect to a reverse connector 50, and will not against the card movement ), if these two connector with same interface signals, it can be the same interface signals pins connector together. It will provide a card with same interface signals but different sizes, it can be one shorter and one longer. For example: SD and Mini SD with similar width similar thickness but with different length can be inserted to the same slot. The Mini SD can have an area with a protruding structure, which may be over the SD card thickness or width, and will against over inserted depth to a slot.

The invention also introduce a different variable length cards, which can be done in other way. A design is that the slot can be designed with only one connector and two cards with a connector, which is the same insertion distance to the end of the card. For example, one connector puts in front of a shorter card, and one connector puts in the middle of the another longer card. When the connector is inserted to slot, both connectors can connect to the connector in the slot. Same it is important that the connector in the slot will not against the longer length card movement.

The invention further provides a memory card, which included a memory body for storing data. A control device has one or two USB interfaces for controlling the data transmission, and optionally is capable of being integrated into the memory body. A dual connector has at least two connection terminals with USB interface. Wherein, the memory card can use a USB interface to connect to an electronic apparatus for data transmission. The other USB interface of the memory card is use to connect to an electronic device, which is installed on the memory card.

The foregoing memory card can optionally have a connection member with the outer appearance similar to a different type of memory card, so that the memory card can be inserted into a slot of the different type memory card.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a drawing, schematically illustrating a plug for USB series A;

FIG. 2 is a drawing, schematically illustrating a receptacle for USB series A

FIG. 3 is a drawing, schematically illustrating a plug for USB series Mini-A;

FIG. 4 is a drawing, schematically illustrating a receptacle for USB series Mini-A;

FIG. 5 is a drawing, schematically illustrating a plug for USB series Mini-B;

FIG. 6 is a drawing, schematically illustrating a receptacle e for USB series Mini-B;

FIG. 7 is a drawing, schematically illustrating a plug, according to an embodiment of the invention;

FIG. 8 is a drawing, schematically illustrating a metal frame of the plug with one protruding part in FIG. 7;

FIG. 9 is a drawing, schematically illustrating a metal frame of the plug with one opening in FIG. 7;

FIG. 10 is a drawing, schematically illustrating a second holder of the plug with one protruding part in FIG. 7;

FIG. 11 is a drawing, schematically illustrating the plug with a protection cover as shown in FIG. 7;

FIG. 12 is a drawing, schematically illustrating the second holder of the plug with a reduced thickness FIG. 7;

FIG. 13 is a drawing, schematically illustrating the plug in FIG. 7 for application on a silicon disk;

FIG. 14 is a drawing, schematically illustrating the plug in FIG. 7 for application on an IC card;

FIG. 15 is a drawing, schematically illustrating the plug in FIG. 7 for application on a CF card;

FIG. 16 is a drawing, schematically illustrating the plug in FIG. 7 for application on an SD card;

FIG. 17 is a drawing, schematically illustrating the plug in FIG. 7 about the mechanism of using the cable to connect with outer devices;

FIG. 18 is a drawing, schematically a plug with reduced thickness, according to the invention; and

FIG. 19 is a drawing, schematically a structure of the conventional IEEE 1394a connector.

### DETAILED DESCRIPTION

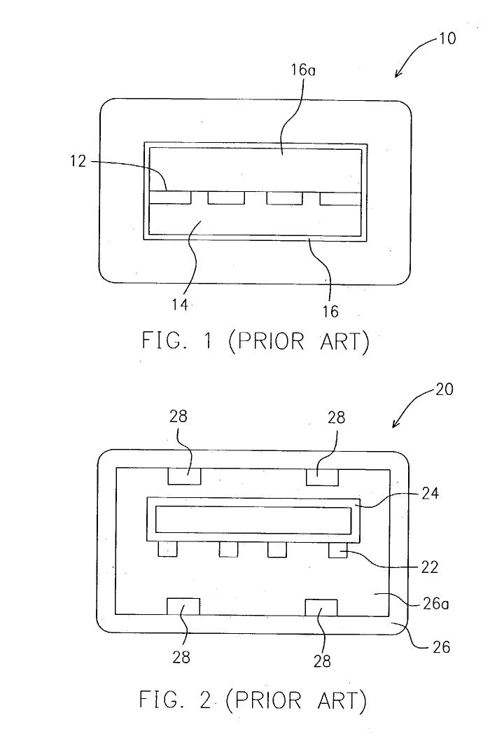

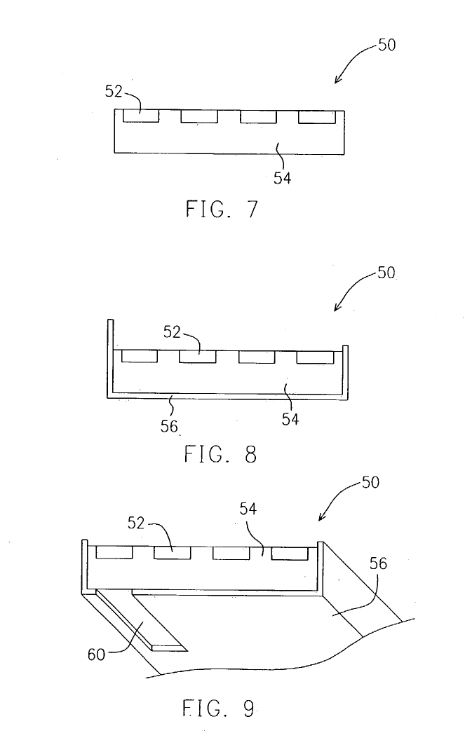

Referring FIG. 7, FIG. 7 is a drawing, schematically illustrating a plug 50, according to an embodiment of the invention. In FIG. 7, the plug 50 includes a number of metal connection terminals 52 being exposed, used to electrically connect to a number of metal connection terminals 22 on a first holder 24 inside the receptacle 20 when the plug 50 is connected with the receptacle 20 in FIG. 2. A second holder 54 is used to hold the metal connection terminals 52 and at least one at bottom of the elastic plate 28 on the outer frame 26 of the receptacle 20 when the plug 50 is connected with the receptacle 20, or two elastic plates 54 at bottom are to elastically contact the second holder 54. So, it affixes the plug 50, in which at least one of the multiple elastic plates 28 on the outer frame 28 at the top will not contact with the plug 50. Wherein, each element in the plug 50 can have correspondingly similar specification and appearance, so as to assure that the USB plug 50 is compatible with the USB receptacle 20. However, the specification and the appearance can also be modified. For example, the metal connection terminals 52 can be the protruding points. It has been sufficient to only need a good contact between the metal connection terminals 52 of the plug 50 and the metal connection terminals 22 of the receptacle 20. It is also not always necessary for the second holder 54 to cover the bottom of the metal connection terminals 52. The second holder 54 can, for example, only hold the metal connection terminals 52 from the bottom for affixing. The plug 50 can also include an outer frame of a metal frame 56 or a non-metal frame, so as to connect to the outer frame 26 of the receptacle 20. One of the purposes of the second holder 54 or the metal frame 56 is to connect in contact with the outer frame 26 of the receptacle 20, so as to provide the affixing function by contact. However, the second holder 54 can be properly adjusted on the thickness, so as to assure that the elastic plates 28 can have the affixing effect. Since the multiple metal connection terminal 22 on the first holder 24 are the design of elastic plates, it not only can assure the electric connection with the metal connection terminals 52 on the second holder 54, but also it has the affixing effect on the plug 50 by associating with the multiple elastic plates 28. The conventional USB plug 10 has the thickness of 0.45 cm, and the plug 50 has the minimum thickness, which allows to be plugged into the space between a bottom of the outer frame 26 of receptacle 20 and the first holder 24, wherein it has been sufficient to allow the multiple metal connection terminals 52 to have good contact with the multiple metal connection terminals 22 on the receptacle 20. The thickness can be less than 0.24 cm or even down to about 0.18 cm. Optionally, a protruding part for avoiding a reverse connection can be included, in which some portion would be thicker. However, the thickness of the plug 50 can be less than the USB series A plug 10 by 0.45 cm or less. In this manner, it can be implemented on a CF card with thickness of 0.33 cm, a memory stick card with thickness of 0.28 cm, a SD card with thickness of 0.21 cm, a XD card with thickness of 0.17 cm, a memory stick duo card with thickness of 0.16 cm, a Microdrive card, a PCMCIA card, a thinner USB silicon disk, a ATA Flash card, or an electronic device, since the plug 50 can be used in light and small portable memory device. The plug 50 structure still supports enough strength connect to a receptacle.

When the plug 50 is connected to the receptacle 110 in FIG. 4, the metal connection terminals 52 being exposed are used to electrically connect the multiple metal connection terminals 112 on the first holder 114 inside the receptacle 110. The second holder 54 is used to hold the metal connection terminals 52 and affix the plug 50, wherein at least one of the multiple elastic plates 118 on the outer frame 116 of the receptacle 110 can elastically contact the second holder 54 to affix the plug 50 when the plug 50 is connected to the receptacle 110. Wherein, each element of the plug 50 can have the similar specification and appearance with the corresponding elements of the USB plug 100, which is to be connected to the USB receptacle 110, so that the plug 50 is compatible with the USB receptacle 110. However, the specification and the appearance can be changed. For example, the metal connection terminals 52 can be the protruding points. It has been sufficient to only need the good contact between the metal connection terminals 52 of the plug 50 and the metal connection terminals 112 of the receptacle 110. It is also not always necessary for the second holder 54 to cover the bottom of the metal connection terminals 52. The second holder 54 can, for example, only hold the metal connection terminals 52 from the bottom for affixing. The second holder 54, in thickness, can be properly adjusted to assure that the elastic plates 118 can effectively perform the affixing function. Since the multiple metal connection terminal 112 on the first holder 114 are the design of elastic plates, it not only can assure the electric connection with the metal connection terminals 52 on the second holder 54, but also has the affixing effect on the plug 50 by associating with the multiple elastic plates 28.

Likewise, when the plug 50 is connected to the receptacle 40 in FIG. 6, the metal connection terminals 52 being exposed, are used to electrically connect the multiple metal connection terminals 42 on the first holder 44 inside the receptacle 40. The second holder 54 is used to hold the metal connection terminals 52 and affix the plug 50, wherein at least one of the multiple elastic plates 48 on the outer frame 46 of the receptacle 40 can elastically contact the second holder 54 to affix the plug 50 when the plug 50 is connected to the receptacle 40. Wherein, each element of the plug 50 can have the similar specification and appearance with the corresponding elements of the USB plug 30, which is to be connected to the USB receptacle 40, so that the plug 50 is compatible with the USB receptacle 40. However, the specification and the appearance can be changed. For example, the metal connection terminals 52 can be the protruding points. It has been sufficient to only need the good contact between the metal connection terminals 52 of the plug 50 and the metal connection terminals 42 of the receptacle 40. It is also not always necessary for the second holder 54 to cover the bottom of the metal connection terminals 52. The second holder 54 can, for example, only hold the metal connection terminals 52 from the bottom for affixing. The second holder 54, in thickness, can be properly adjusted to assure that the elastic plates 48 can effectively perform the affixing function. Since the multiple metal connection terminals 42 on the first holder 44 are the design of elastic plates, it not only can assure the electric connection with the metal connection terminals 52 on the second holder 54, but also has the affixing effect on the plug 50 by associating with the multiple elastic plates 48. The USB series mini-A plug 30 or the mini-B plug 100 have the thickness of 0.3 cm. The minimum thickness of the plug 50, which allows to be plugged into the space between a bottom of the outer frame 46 of receptacle 40 and the first holder 44. Wherein, it has been sufficient to allow the multiple metal connection terminals 52 to have good contact with the multiple metal connection terminals 42 on the receptacle 40. The thickness of the plug 50 can be less than 0.15 cm or even down to about 0.08 cm. Optionally, a protruding part for avoiding a reverse connection can be included, in which some portion would be thicker. However, the thickness of the plug 50 can be less than the 0.3 cm. Thickness USB series mini-A plug 40 and mini-B plug 110. In this manner, it can be implemented on a CF card with thickness of 0.33 cm, a memory stick card with thickness of 0.28 cm, a SD card with thickness of 0.21 cm, a multimedia card by 0.14 cm, a smart card with thickness of 0.076 cm, a XD picture card with thickness of 0.17 cm, a memory stick duo card with thickness of 0.16 cm, a Microdrive card, a PCMCIA card, ATA flash card, IC card, SIM card, or a thinner USB silicon disk, or an electronic device. Since the plug 50 be used in light and small portable memory device, the plug 50 structure has enough strength support connect to a receptacle.

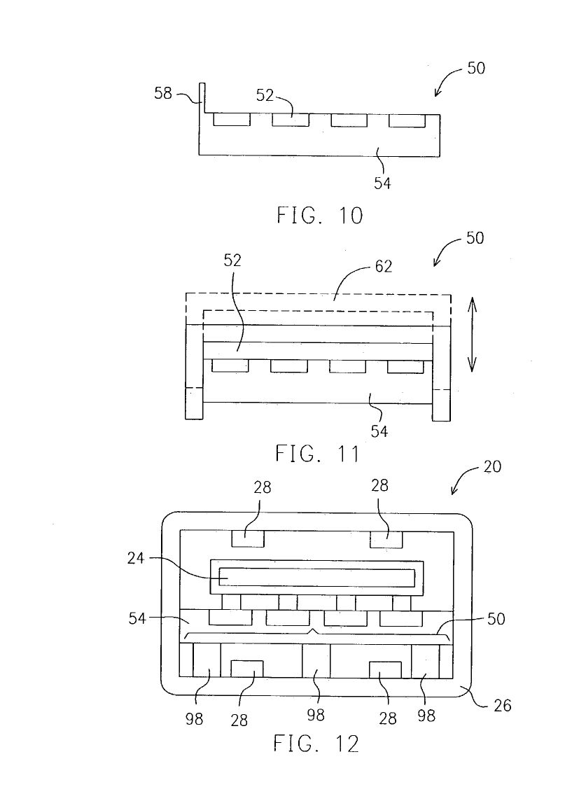

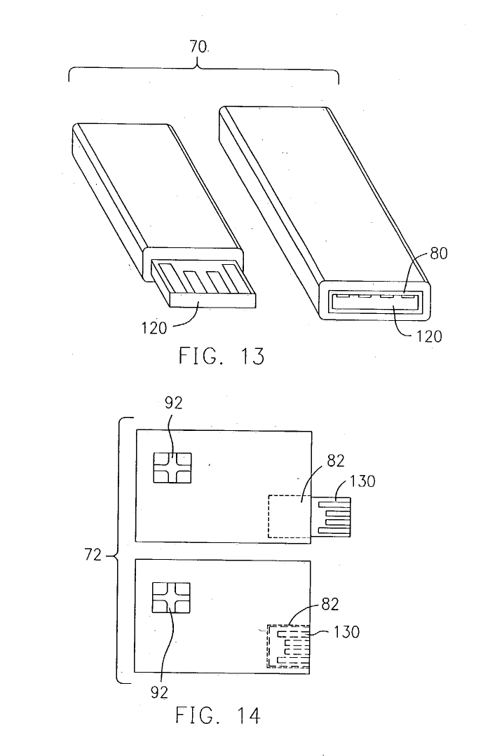

Referring to FIG. 8 and FIG. 9, in order to keep some affixing function for the metal frame of the conventional USB plug when the USB plug is connected to the USB receptacle and is affixed, under the condition without affecting the thickness of the plug 50, a metal frame 56 can be implemented on the bottom or on the edge of the second holder 54 in the plug 50. In this manner, the metal frame 56 is used to affix the plug 50 to the outer frame 26, 116, 46 of the receptacle 20, 110, 40 by contact friction and the outer appearance. When the user accidentally intends to connect the plug 50 to the receptacle 20, 110, or 40 in reverse direction, the power source terminal Vcc and the grounding terminal GND of the metal connection terminals 22, 112, or 42 of the receptacle 20, 110, or 40 may have contact with the metal frame 56. Since the material of the outer frames 26, 116, or 46 are metallic material, when the power source terminal and the grounding terminal contacts each other, a short circuit will occur. This short circuit is easy to cause the receptacle 20, 110, or 40 to be breakdown or malfunction for the device using the receptacle 20, 110, or 40.

Please note that, in the USB series A in FIG. 2, the receptacle 20 has a first space 26a between the first holder 24 and the outer frame 26. This conventional design is used to adapt the metal frame 16 when the USB series A plug 10 is connected with the receptacle 20. In FIG. 4 for the USB series Mini-A, the receptacle 110 has a first space 116a between the first holder 114 and the outer frame 116. This conventional design is used to adapt the metal frame 106 when the USB series Mini-A plug 100 is connected with the receptacle 110. In FIG. 6 for the USB series Mini-B, the receptacle 40 has a first space 46a between the first holder 44 and the outer frame 46. This conventional design is used to adapt the metal frame 36 when the USB series Mini-B plug 30 is connected with the receptacle 40.

FIG. 8 is a drawing, schematically illustrating the plug 50 according to the first embodiment of the invention. In FIG. 8, at least one side of the metal frame 56 of the plug 50 has protruding part by a distance from the second holder 54. The metal frame 56 will be plugged into the first space 26a, 116a, or 46a when the plug 50 is connected to the receptacle 20, 110, or 40. When the plug 50 is connected in reverse direction, since the shape for the first space 26a, 116a, or 46a is different from the right connection, the metal frame 56 will not be smoothly plugged into the first space 26a, 116a, or 46a. By this mechanism, it can prevent a reverse connection for the metal frame 56 from occurring. FIG. 9 is a drawing, schematically illustrating the plug 50 according to the second embodiment of the invention. In FIG. 7, the metal frame 56 of the plug 50 has an opening part 600. The opening part 600 is located at the place, where would match to the power source terminal of the metal connection terminals 22, 112, or 42. In this manner, when the plug 50 is connected in reverse direction to the receptacle, the short circuit will not occur between the power source terminal and the grounded terminal although the power source terminal has contacted with the metal frame 56.

Referring to FIG. 10, FIG. 10 is a drawing, schematically illustrating the plug 50 according to the third embodiment of the invention. With similar foregoing reasons, in order to prevent the reverse connection for the plug 50 to the receptacle 20, 110, or 40, the plug 50 is designed to have at least one protruding part 58 at the edge of the second holder 54. The protruding part 58 will be inserted into the first space 26a, 116a, 46a when the plug 50 is connected to the receptacle 20, 110, or 40. When the plug 50 is connected in reverse direction, since the shape for the first space 26a, 116a, or 46a is different from that in right connection. The protruding part 58 then cannot be smoothly inserted into the first space 26a, 116a, or 46a. In this manner, the protruding part 58 can prevent the plug 50 from being reverse connection. An LED can also used to indicate whether or not the connection is correction. Furthermore, for example, since mini type IEEE 1394 plug and receptacle has the same structure as USB mini type connector, but with different pin pitch and size and different connector shape and size, the way of thickness modify done in USB connector, also can done in IEEE 1394 mini plug connector.

Referring to FIG. 12, FIG. 10 is a drawing, schematically illustrating the plug 50 according to the fifth embodiment of the invention, wherein the actual situation is shown when the plug 50 of the invention is connected to the USB receptacle 20, 40, 110 in FIGS. 1, 4, and 6. For convenient descriptions in FIG. 1, the receptacle 20 is used as the example. In order to further reduce the thickness of the plug 50 with respect to various needs, the thickness of the plug 50 can be reduced down to a degree, at which the plug 50 second holder 54 will not contact with the elastic plates 28, 48, 118 when the plug 50 is connected to the receptacle 20, 40 and 110, and the second holder 54 in the plug 50 can be implemented with a number of elastic plates 98 at the bottom side to have contact with the metal frame of the receptacle 20, 40, 110. Or, second holder 54 has a metal frame rack in bottom or both side touch the bottom outer frame of receptacle 20, 110, or 40, is used to strengthen the connection effect. The metal connection terminals 52 of the plug 50 can be a design of elastic plate.

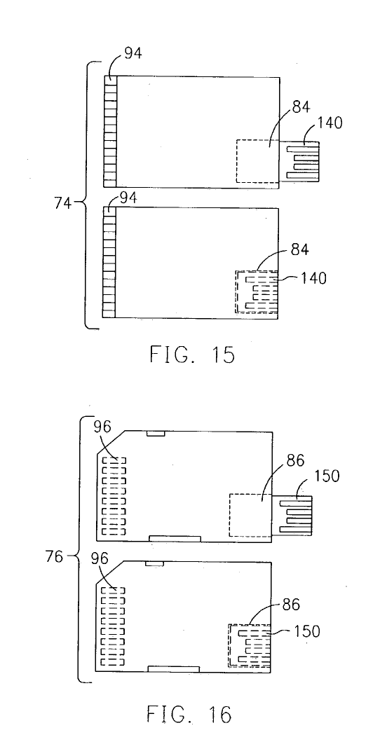

In the invention, the plug 50 and the embodiments 1-5 have disclosed several options. The plug 50 of the invention can effectively reduce the thickness of the conventional USB plug, so as to be suitable for use in various electronic devices. The present invention can be also applied to IEEE 1394a or 1394b connector, which is similar to the mini USB connector. The different is the size and the outer appearance. However, the connection mechanism and the electronic signal transmitted between the plug and the receptacle are similar to the mechanism in the USB case. The present invention can also be applied to the IEEE 1394a and 1394b connectors. Referring to FIGS. 13-16, FIG. 13 is the example for actual application using the plug 50 as shown by a plug 120, which is implemented on a USB silicon disk drive 70 without using the manner of cable connection. Wherein, the plug 120 can be the plug 50 shown in FIG. 7. The silicon disk drive 70 has a indent space 80. The plug 120 can be implemented on the indent space 80 by a non-retractable manner. The plug 120 can also be implemented on the silicon disk drive 70 by a protruding and non-retractable manner. The protruding plug 120 can be directly connected to a USB receptacle, and the receptacle 20, 110, 04 40 of a cable can also be directly connected to the plug 120 on the indent space 80. The plug 120 can also be implemented in the indent space 80 by the retractable manner. When the plug 120 is to be connected to the receptacle 20, 110 or 40, the plug 120 can then be shifted out from the indent space 80. When the plug 120 is not to be connected to the receptacle 20, 110, or 40, the plug 120 can be retracted into the indent space 80.

FIG. 14 is the example for the second actual application using the plug 50 as shown by a plug 120. An IC card 72 has the metal connection terminals 92 used by a reading apparatus to read data, but also has a plug 130, which can be the plug 50 shown in FIG. 7 and is implemented on the IC card 72 without cable connection. The IC card 72 has an indent space 82. The plug 130 can be implemented on the indent space 82 or protruding from the IC card 72 by a non-retractable manner. The receptacle 20, 110, 40 of a cable can also be directly connected to the plug 130 in the indent space 82. The plug 130 can also be implemented in the indent space 82 by a retractable manner. When the plug 130 is to be connected to the receptacle 20, 110 or 40, the plug 130 can then be shifted out from the indent space 82. Alternatively, the plug 130 can also be disposed in the indent spacer 82 and when it is to be used, the plug 130 is shifted out by rotating an angle of 90 or 125 degree or others. The metal connection terminals of the plug 130 being shifted out are connected to the chip of the IC card 72 via a conductive line, so that the plug 130 can be directly connected to the receptacle 20, 110, or 40 of the computer. When the plug 130 is not to be connected to the receptacle 20, 110, or 40, the plug 130 can be retracted into the indent space 82. The plug 130 can be optionally implemented on a memory card. For example, a corner of a chip card 72 has a slant angle, such as 30 degrees. The two sides of the plug 130 is a free space, so as to avoid the blockage on the plug 130 to be inserted into the USB connector by the chip card 72 due to his volume. This would seriously affect the outer appearance of the chip card 72. If the inserted one is the USB cable, then the plug 130 still leaves the space at both sides of the plug 130.

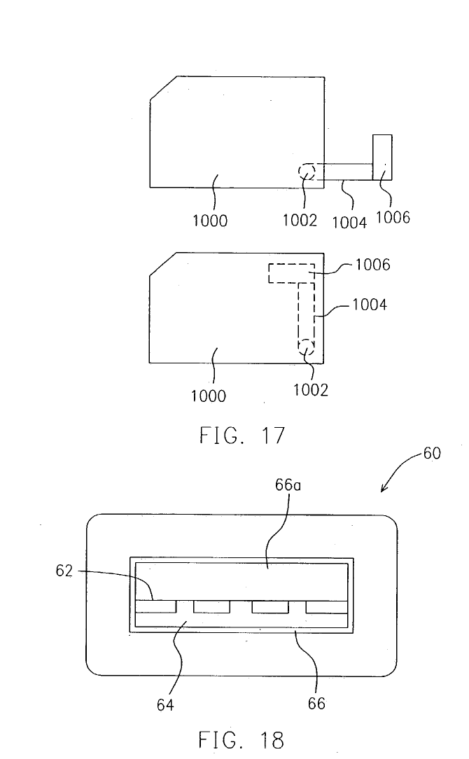

FIG. 15 is the example for the third actual application using the plug 50 as shown by a plug 140. A CF card 74 has a slot 94 for use by digital camera to access the data. Also and, a plug 140 is implemented on a CF card 74, wherein the plug 140 can be the plug 50 in FIG. 7. The CF card 74 has an indent space 84. The plug 140 can be implemented in the indent space 84 by a non-retractable manner, wherein the plug 140 can also be exposed or two sides of the plug 140 have open gaps. The receptacle 20, 110, or 40 of a cable can also be directly connected to the plug 140 in the indent space 84. The plug 140 can be implemented in the indent space 84 by a retractable manner. When the plug 140 is to be connected to the receptacle 20, 110 or 40, the plug 140 can then be shifted out from the indent space 84. Alternatively, the plug 140 can be disposed in the indent spacer 84 and when it is to be used, the plug 140 is shifted out from the CF card by rotating an angle. The plug 130 can thereby be directly connected to the receptacle 20, 110, or 40 of the computer. When the plug 140 is not to be connected to the receptacle 20, 110, or 40, the plug 140 can be retracted into the indent space 84. The appearance of the CF card 74 is then returned and can be inserted into the slot of the digital camera, a memory card with a long-thin shift out plug 40, will be easier to inset into receptacle, because a CF size will touch other nearby cable and against the inset action. This is the reason why USB silicon disk was long-thin shape. The CF card with dual connector can be adapted by a CF-card slot and also by a single CF slot for connecting to a USB interface. This is easy for use by the user.

One design is as follows. Plug 140 also can be shifted out from the CF card (master card) or other memory card, together with at least one memory card and at least one controller chip. As a result, it becomes an independent memory card, the controller chip for controlling the data storage and transmission can be integrate into the memory card. The controller has the function to control the system and data transfer. As a result, after the plug with the memory card is shifted out, the shifted-out independent memory card can be completely separated from the master card, or alternatively still has some mechanical connection without complete separation. Thus, it is convenient for the action of retracting back into the master card. The master card can optionally include one controller chip for controlling the information transmission. The independent memory can be inserted into a computer USB port, and become an independent memory card, like a USB memory card. Therefore, it is smaller than a CF card and can be designed with long thin shape to easy insertion to the USB PORT slot. The independent memory card can be retracted back to the master card.

When the plug 140 of the independent memory card is retracted, it can be connected to a USB interface connector A in the master card (memory transfer card), for example, a memory stick transfer card (master card) with a USB interface connector A and with another memory stick card standard 7 pins connector E, so that the 7 pins of the connector E on the memory stick transfer card can be connected to the inserted electronic device, such as the digital camera, for transmitting data. The control device function transfers different type of memory card connector signals for example: memory stick card 7 pins connector E signals, to the USB interface signals or others to the connector A, with a function as a USB Host Mode. One option is to limit the USB communication protocol only connect to a memory card, to simplify the design, then the independent memory card having a USB interface connector B can connect to connector A. The independent memory card can be designed with only one USB interface and connect to two connectors, and only allow one connector data communication at same time to save one USB interface, or design with two USB interfaces and connect to two connectors, or design with only one USB interface and connect to only one connector A. It can be designed that when independent card is connected to master card, the other connector in independent memory card can still insert to a computer USB port for data communication, since at this time when the master card didn”t insert to a device, and no power supplyfrom master card, and control device can set to disable. Use only one USB interface a design is: a manual switch and optionally select connect independent memory card USB interface connector B to connector A or connect to external connector. Or USB interface connector B can be manually moved (example: a rotation plug) to connect connector A or connect an external device USB port, then only one USB interface still works. Also and, the independent memory card can be USB interface directly connected to electronic device via the at least one of the 7 pins on the memory stick transfer card, the independent memory card can optionally inside the memory stick transfer card (master card), or it was connected with the memory stick transfer card, and connect together can be with the outer shape, the outside shape can inserted to a standard memory stick card slot, and function like a standard memory stick card. And can be optionally design with one other connector at independent memory card another side, and able connect to a computer USB port, or another way is the independent can take out and able connect to a device USB port, the design needs no card reader, in the upper different case, USB interface connector can be a non-standard USB connector, being thinner, so for being able to be installed in a memory stick card or other memory card, the upper different design can be done in different types of memory card.

There are many options about how the data is transferred between the memories to the inserted digital camera device, and many different connector design options. One design is that the plug 140 of the independent memory card combined with a master card, which can also be directly connected to a USB connector inside a digital camera for information communication The master card then passes the USB signals through 4 of 7 pins of a connector to anotherconnector A, so that the function of the master card can be just to mechanically support independent memory card and the mechanical member for insertion into the memory stick slot. The memory card, such as a memory transfer card combined with the independent memory card or memory transfer card with independent memory card inside, can optionally include a connection member with the outer appearance similar to a different type of memory card, so that the memory card can be inserted into one slot of the different type memory card.

Another consideration of the invention is that since a memory card thickness may be less than 0.21 cm or 0.14 cm, it is very important to take care the component and the mechanical design, many memory card PCB”s (printed circuit board) and memory card design is, a PCB with chip at top side and at bottom side of pcb and connect to the PCB, but is one side of the memory card need a lot of connection terminals like a exposed contact points, then it will not easy connect to the pcb, one invention is with soft PCB, then after installed components and memory chips, then the one plane of soft PCB can be rotated or bent to at least two parallel plane, top and bottom at least two layers, the chips can put between two layers, or other place. So this PCB structure dont need a connector to connect two layer of PCB in such thick device.

In the forgoing architecture, the controlling unit can convert the different signal protocol of memory card to the USB signal transmission protocol. The USB interface I/O port member can be, for example, like the structure as shown in FIG. 18 with the rotation part, in which when the connector is put back by, i.e., hand, then it is connected to the USB interface of the master card.

The foregoing design of master card with the independent memory card can also be applied to the other kinds of memory card. The independent card with respect to the master card can optionally include a connection member with the outer appearance similar to a different type of memory card, so that the memory card can be inserted into a slot of the different type memory card. The independent memory card can be retracted into the CF card, and then the CF card can be inserted into the CF slot in, for example, a digital camera. The CF card has the multiple function to provide for, i.e., a USB silicon disk (independent memory card) being coupled together. The independent memory card can be a long thing structure, so that the independent memory card can be plugged into the plug 140 of the computer, without being restricted by the size of the CF card.

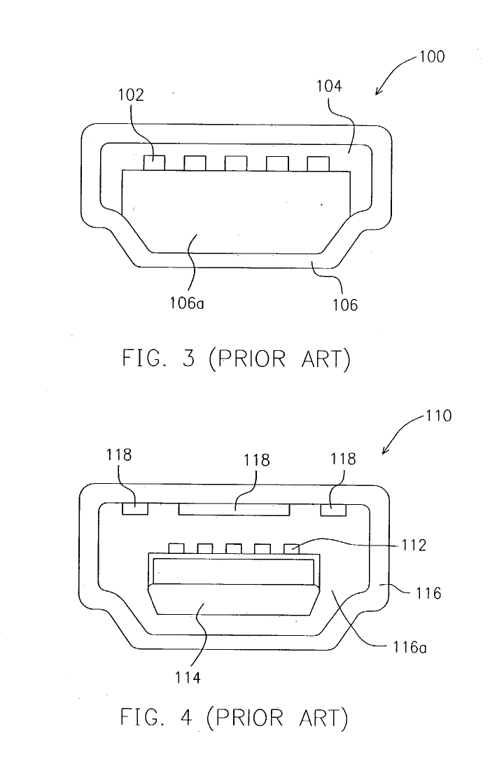

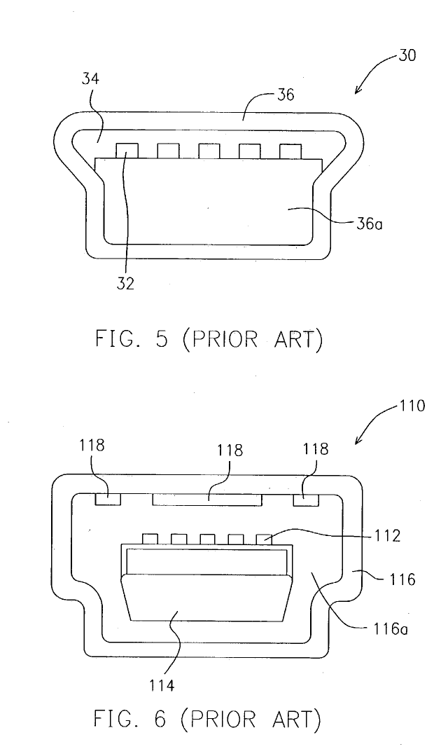

FIG. 16 is the example for the fourth actual application using the plug 50 as shown by a plug 150. A memory card, such as SD card 76, has a slot 96 for use by digital camera to access the data. Also and, a plug 150 is implemented on the SD card 76, wherein the plug 150 is implemented on the SD card without cable, wherein the plug 150 can be the plug 50 in FIG. 7. The SD card 76 has an indent space 86. The plug 150 can be implemented in the indent space 86 by a non-retractable manner, wherein the plug 150 can also be exposed. The receptacle 20, 110, 04 40 of a cable can also be directly connected to the plug 150 in the indent space 86. The plug 150 can also be implemented in the indent space 86. When the plug 150 is to be used, the plug 150 can be shifted out by rotating an angle. The plug 150 can also be implemented in the indent space 86 by the retractable manner. When the plug 150 is to be connected to the receptacle 20, 110, or 40, the plug 150 would be shifted out from the indent space 86. When the plug 150 is not to be connected to the receptacle 20, 110, or 40, the plug 150 can be retracted into the indent space 86. The plug 150 can also be implemented by protruding out from the SD card 76 without retraction. The protruding plug 150 can be directly connected to the USB receptacle of the computer. The SD card can also be disposed into the slot in a digital camera. The plug 120, 130, 140, 150 as shown in FIGS. 13-16 can also be uses in the USB series A plug 10 in FIG. 1, the USB series Mini-A plug 100 in FIG. 3, or the USB series Mini-B plug 30 in FIG. 5.

In the fifth application of the plug 50 in the invention, the metal connection terminals 52 can be changed into, i.e., elastic plates, so as to allow a connector to be inserted into. The connector can be the USB plug 30, 10, 100 in the computer. Likewise, the plug can also be connected to the USB receptacle, or even a reversed arrangement of the plug 50 suitable for use in the actual design.

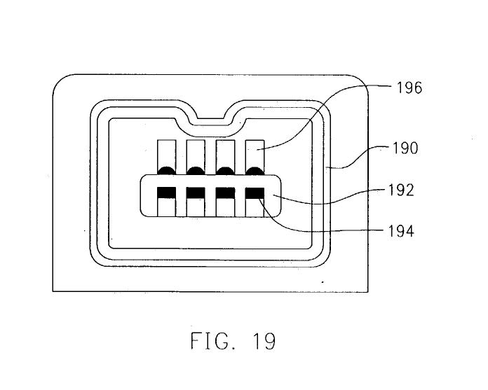

In application 6, it is related to a design of the connectors for the peripheral equipment of the computer and an information storage device. The computer system is, for example, a notebook computer, and the information storage device, for example, is a PDA or storage device. For the storage device of the digital camera, it is, for example, a CF card. After the CF card is released out from the peripheral device of computer, conventionally it needs a reading apparatus to read the information. The information in the CF card can be input to the USB port of the computer via the reading device with the USB connector. The portable information storage device inside the peripheral device of computer or an electronic apparatus can be a silicon disk or memory device, implemented with the conventional plug of USB series A 10, USB series Mini-A 100, or series Mini-B 30. The silicon disk or memory device can also be implemented with a plug of the invention, which can be connected to the receptacle or the plug of USB series A, USB series Mini-A, series Mini-B, series Mini-AB. The silicon disk or memory device can be disposed inside the peripheral device of computer. The peripheral device of computer is implemented with a connector, which can be connected with the plug. This connector can be the receptacle in USB series A 10, USB series Mini-A 100, or series Mini-B 30, or can be the plug 50. In this design, The computer system can download data to the portable information storage with USB mass storage class protocol, the portable information storage device of the peripheral device can be released out and be directly connected or connected via a cable, as shown in FIG. 17. The cable can be, for example, the cable used for converting the receptacle into the plug, in which the data signals are not changed and can be directly connected to the USB port of the computer, and can be read data with USB mass storage class protocol. In this manner, it is convenient for reading the information of the portable information storage device. In FIG. 17, an information storage card 1000 is implemented with the plug 1006 of the invention compatible with the USB specification. The plug 1006 is disposed on the rotation arm 1004. The rotation arm 1004 is mounted on the information storage card 1000 via a rotation member 1002, in which the interconnection line (not shown) is used to extend the connection terminals to the plug 1006. Moreover, as shown in FIG. 16 or FIG. 17, the plug 1006 can also be designed to be directly connected to a connector, even the plug remains in the retraction position, the rotated-out plug can be implemented in memory card or a hard disk, or a PCMCIA card.

For the seventh application, the storage device in the market used by the digital camera has the design of dual slot and dual card, such as the CF slot and SD slot. The peripheral device of computer in implemented with two connectors as a dual connector for adapting the two cards. The user can select one of the two cards to plug into the digital camera. However, since it needs to be implemented with the dual slot, it then needs a larger volume. The invention proposes that a memory card has been installed inside an electronic device, such as a CF card slot with at least two connectors. The CF card can have the original connector with 50 pins, but also have another connector, so as to form a dual-connector card. For example, the another connector can be the exposed plug 50 of the invention, which can be connected to the receptacle of, for example, USB series A, series Mini-A, or Mini-B. Alternatively, the another connector on the card can be the usual USB plug of USB series A, series Mini-A, or Mini-B. The peripheral device is implemented with two connectors inside. The two connectors can be the two connectors of the portable information storage device, which has been inserted. For example, The information storage device has the receptacle for CF card, SD card, or multimedia card as well as another connector. This another connector can be the exposed plug 50 of the invention, which can be connected to the plug or receptacle of, for example, USB series A, series Mini-A, or Mini-B. The electronic device can detect and select one of the two connectors associating with the signals and communication protocol to read the information on the information storage device. In this design, the user has multiple choices to select the portable information storage device. One choice is the CF card, which can be read by the card reading apparatus. One choice is the card with dual connector, in which one connector can be the USB plug of series A, series Mini-A, or series Mini-B, as well as the other connector is the connector of the CF card to connect to the silicon disk or memory device. The memory device has a CF card slot with about conformal shape with the appearance of the CF card, so that it can be released and connected to a computer for reading the information via the USB port. The digital camera can also select a fast transfer rate USB 2.0 to send data to this memory card. One choice is also the card with dual connector, in which one connector can be plug 50 of the invention capable of connecting to the USB plug, or the plug 60 (see FIG. 18, the 10^{th} applications latter). Then, another connector is a CF connector for the silicon disk or memory card. The connection can be the CF slot about conformal to the CF card, is the connector of the CF card to connect to the silicon disk or memory device. One choice is the silicon disk or memory device, which has the CF slot about conformal to the CF card, implemented with a plug 50 or plug 60 of the invention, for connecting to USB series A, series Mini-A, or series Mini-B. Another option is that a design of the CF card like the embodiment three has a master card with the independent memory card. The peripheral device of the computer is implemented with at least two connectors, so that one of the connector of the master card and the connector of the independent memory card, or a single connector to connect to the master card or the independent memory card.

The connecting part inside the electronic device at least includes two connectors. The electronic device of computer can have a single slot, allowing different card to be plugged in, wherein the slot can be connected to the at least two connectors or single connector on the card, which has been plugged into the single slot. In this manner, for example, it only needs a CF-card slot, which is rather small in size, and can allow the different information storage cards to be plugged in for use. Optionally, the electronic device has the capability to detect the specification of the inserted memory card and select the proper type of data transmission and a faster speed of data transmission can be thereby selected. For example, a USB 2.0 is used to connect to one of the dual connector of the memory card, and can still keeps the function to connect a standard one connector CF card, which has been widely used. This method is also suitable for easy use in the memory card with different specification.[0069] The electronic device (USB host) can use inner connector satisfying the protocol of the USB mass storage, so that it can use the memory card (USB device) for data storage and transmission. The memory card can be dismounted. The electronicdevice can use the same protocol of USB mass storage to communicate with the memory card for information transmission.

With respect to the information storage card installed in the digital apparatus, the single storage card can have two different connectors, of which one can be the plug of the invention in reduced thickness for the USB connecting manner. As a result, the information storage card can used the USB interface manner to be directly connected to the external apparatus, such as the computer system.

With respect to a memory card installed in an electronic device, a standard USB connector may be not suitable for being installed on a slim memory card due to over thickness. However, the USB interface is a standard commonly used, so as to provide a standard protocol for data communication and to be easy for data communication with the computer. A design of the invention is that a single memory card can be installed with at least one USB interface. The at least one USB interface has multiple signal terminals including the power, Gnd, D+, and D−. The multiple signal terminals of the interface can be exposed, so as to be used for a slim memory card. When the memory card is plugged into a memory-card slot of the electronic device, it can provide multiple naked-like terminals (for example, multiple terminals of a SD card, contacting the terminals on the connector of the SD card. The terminals of the memory card can be the 9 pins of the original SD or connection terminals on the SD card). The connection function is achieved by contact the terminals. As a result, the data communication with the USB interface still can be commonly used by the users. After the memory card is released out, the connector of the interface can be designed to include the USB plug of the invention with exposed terminals and reduced thickness. Thus, the memory card can use the USB manner to connect to the external system, such as the computer system. The computer can easily access the data in the memory card by the USB interface. The memory card can optionally has a connection member for the different memory type, so that it can be inserted into a slot of the different memory type. The terminals of the USB interface can be designed by the exposed manner, suitable for installation on a mobile electronic device. For example, it can be installed in a network communication card and is plugged into the PDA.

With respect to a memory card inside an electronic device, since the thickness of the IEEE 1394a and 1394b connectors is too thick, they are not suitable for use by the memory card in thin and light design. However, IEEE 1394a interface is very commonly used in the field as a standard for access data. Also and, it is convenient for data transmission through the IEEE 1394. One design is as follows. A single memory card is implemented with at least one IEEE 1394 interface, which has a plurality of connection terminals including power, Gnd, D+, and D−. the connection points of the IEEE 1394 interface are exposed, so as to satisfy the requirements for a thinner memory structure. When the memory card is inserted into the electronic device, the memory card can provide the exposed connection terminals, such as the connection terminals of the SD card to have contact with the connection terminals of the SD slot. The connection terminals of the memory card can be a few of the original standard 9 pins or the multiple connection terminals on the SD card. The connection terminals provide the connection function between the electronic device and the memory card by the IEEE 1394 protocol that has been widely used. The connector of the interface can include the IEEE 1394 connector of the invention by the reduced thickness, and therefore the memory card can use the IEEE 1394 to connect to an external system, such as a computer system. The computer system is usually installed with the IEEE 1394 interface for accessing data. The memory card with IEEE 1393 interface can optionally has a connector specification used by the different type of memory card, so that the memory card can be inserted to a slot, which is other than the current specification of IEEE 1394.The multiple connection terminals of the IEEE 1394 interface are exposed. These exposed connection terminals can also be implemented on the other mobile electronic device, such as a network card or a PDA.

The electronic device can be designed to connect with different type memory card at the same I/O port A, with such as a SD card port C, an IEEE interface cardor a USB interface card port D. Thus, it can have different protocol in data communication and different signal form. For example, the electronic device has the standard 9-pin connector for the SD card but the connected part into the slot can be the terminals to connecting the 9-pin or a card with the appearance similar to the SD card, which has the USB connection terminals or other type of interfacing terminals. The electronic apparatus or device has the detection function to detect the specification of the connected one, so that a proper communication protocol can be set up for communication. The detection function can be a detection of the communication protocol, or can be a switching detection. When the card with the appearance of the SD card is plugged in, the switching device is triggered. However, the standard SD card will not trigger the switching device. The detection function can also be a signal from a terminal of the SD appearance-like card. When the SD appearance-like card is plugged, the electronic device will detect the signal on the specific terminal. For example, when the SD appearance-like USB card is plugged, two of the 9-pin of the electronic device are conducted. However, when the standard SD card is plugged, the switching device will not be triggered. Alternatively, the voltage level or the impedance on the connected terminal can be detected for discerning. Or, even a specific signal on the specific terminal can be detected. In this manner, it is possible to detect a SD card appearance but with the USB interface or the IEEE 1394 interface. One specific terminal of the memory card can be optionally set to contact with a terminal of the I/O port D. The SD appearance-like card can have multiple terminals of USB interface and the structure of the connector can be connected to a USB connector of the external electronic device, such as a computer. Thus, a memory card, such as the SD card, only needs one USB interface. It is not necessary to install two USB interface because the two connectorscan share the same USB interface.

Therefore, a connection structure between an electronic device and a USB interface in the invention can be as follows. Inside the electronic device, it includes a connector, a slot with a connector of USB interface, and a structure member for adapting the installation and connection of the USB interface to the memory card. Wherein, the USB-interface memory card can be plugged into an inner part of the electronic device for connecting with the connector of USB interface in the slot and for data communication. Wherein, a connector A of the USB-interface memory card is connected to the connector B of the USB-interface slot. Optionally, a little area of the memory card can still stay outside of the electronic device, so as to pull out an inserted card. The electronic device can be a USB host side optionally as a connector of USB interface, for connecting with memory card by a USB interface. It can reduce the complexity of USB protocol design. The USB-interface memory card optionally has a structure member, disposed in a slot, which can adapt one of various types of memory card. The position of the USB-interface connector B of the memory card can be at the connector C, which adapts one of different type of memory card. In this manner, a connector D, which usually adapts one of the different type of memory card, can be the connector B serving as the signal lines. For example, the proper signals can be determined to connect to the USB-interface memory card. Thus, the electronic device only needs the connector B, which can adapt any one of various types of memory cards.

For example, a digital camera has a control device coupled with the memory card slot, such as a SD card slot with 9 pins. Further still, a detection device can detect the specification of the memory card, which has been inserted. The control device can select the proper signals in proper data transmission protocol, according to the detection results. For example, a SD card, a USB-interface card, or a IEEE 1394 interface card can be inserted. Then, the detection device and the control device can detect the right data specification, and perform the data transmission under the proper protocol via the 9-pin connector. Since the position of the four connection terminals of the USB-interface card gas to correspond to the position of four pins of the 9-pin SD connector, for example, the two pins of Vcc and Gnd can be set to be the same for the two different cards. The USB card can have another USB-interface for connecting to the USB connector installed at the computer. The user”s digital camera can be plugged with a SD card, a USB-interface memory card, or an IEEE1394-inetrface memory card. In this manner, for example, the camera implemented the SD slot can also adapt the USB-interface memory card and the IEEE1394-inetrface memory card by including a control/detection circuit to switch the proper connections without need of additional different slots. Also and, since the control/detection circuit can be implemented separating from the internal circuit design of the digital camera. It can also be not necessary to change the conventional digital camera mechanical structure. However, the circuit can also be implemented in the digital camera as a part of the function of the digital camera, the control device have the signals connect to the connector in the slot for SD card signals interface, if the signals have multi-function, with SD or USB interface signals switch ability, then the signals path in PCB and the layout need not to be changed too, it will with original camera mechanical and PCB, but able communication with a USB interface memory card being inserted in the original slot.

Another design of the invention of the memory card includes a memory body used to store information. A control device, having at least two USB interface, is used to control the data communication. The control device can optionally be integrated with the memory body. A dual connector has a connection side for connecting at least two USB interfaces, in which the memory card uses a connector of USB interface to connect the electronic device for data communication. The another connector of the memory card of USB interface can connect to the memory card mounted on the electronic device for data communication.

Alternatively, the memory card includes a memory body for storing information. A control device, having one USB interface, is used to control the data communication. The control device can optionally integrated with the memory body. A dual connector has a connection side for connecting to only one USB interface, in which the memory card uses the connector of USB interface to connect the electronic device, such as a computer, for data communication. The another connector is to connect a memory card on a electronic device, such as a digital camera, for data communication, these two connectors will not use in the same time for data communication.

The outer appearance of the different memory card is compatible for plugging into a slot for one selected from the group consisting of an IC card, a CF card, a SD card, a XD picture card, a memory stick duo card, a memory stick card, a multimedia card, a MG memory stick card, a smart media card, a Microdrive card, a PCMCIA card, a SIM card, and an IC card.

For the eighth application, one connector is to be connected to one connector on the CF card as shown in seventh application. The connector can be the plug 50 of the invention, which can be connected to the USB plug or the USB receptacle of series A, series Mini-A, series Mini-B. The connector can be the plug 50 with the metal connection terminals 52 as the elastic plate. The plug 50 in implemented with a second holder 54, so as to hold the metal connection terminals 52, which can be a design of elastic plates. In this manner, the plug 50 can be connected to another reversed plug 50 from up side or down side. The second holder 54 in the plug 50 can be implemented with at least a protruding part 58 at the edge, so as to prevent a reversed connection from occurring.

The connector 50 metal connection terminals 52 with the elastic plate can be installed in SD or MS card and connect to a cable with USB series Mini-A, series Mini-B.plug. It can also be with a protruding under or at both side of the connector 50 and increase the fix strength and against reverse inserted, the Mini-A, or Mini-Bplug outer frame inserts between the connector 50 and the protruding, since the top frame of Mini-A, or Mini-B.plug is thicker than bottom side of the frame. Thus, when a reverse insertion is made, the Mini-A, or Mini-B.plug top frame will not be able to insert into the gap space between the protruding and connector 50, and the connector 50 thickness will be close to 0.21 cm, and capable of replacing with the Mini-A, or MiniB.receptacle (0.4 cm thickness) and being installed in SD or MS card.

Another design is with protruding in connector 50 both side, will increase the fix strength and the shape of the protruding will prevent the reverse insertion. And thickness will less than 0.21 cm, Optionally, a top side protrudingcan be included to protect the connector 50 contact point, but will not prevent reverse insert, and connector 50 add top side protruding thickness will less than 0.28 cm.

In ninth application, one connection apparatus, used in the computer system as described in seventh application, has the design of at least two connector, so as to connect to at least two different connectors on a single information storage card. One of the two connector can be the connector as described in eighth application and the other one is used to be connected to a memory card, such as IC card, CF card, SD card, multimedia card, XD picture card, memory stick duo card, secure multimedia card, memory stick, MG memory stick, a Microdrive card, a PCMCIA card, a SIM card, or smart media card. The single data storage card can include a master card with an independent card design, as described in embodiment 3.

In tenth application, referring to FIG. 1again, a conventional USB series A plug 10 has the thickness of 0.45 cm, which can be plugged into the USB series A receptacle 20 in FIG. 2. The plug 10 has multiple metal connection terminals 12, used to be connected to have the electrical connection with the multiple metal connection terminal 22 on the first holder 24 of the receptacle 20 when the plug 50 is connected to the receptacle 20. The metal frame 16 of the outer frame is used to contact in connection with the outer frame 26 of the receptacle 20.

Referring to FIG. 18, it is a drawing, schematically illustrating another plug with reduced thickness according to the invention. The invention is implementing another plug 60 on a memory card, such as a CF card. The plug 60 has a reduced thickness by less than about 0.38 cm or even down to 0.28 cm, which is less than the thickness of the conventional USB series A plug. It can satisfy the requirement from the CF card by 0.33 cm or approach to the thickness of the memory stick card by 0.28 cm, so as to achieve the thickness used in PCMCIA card. As a result, the plug 60 can be implemented on the CF card or the memory stick card. It only needs to allow to be plugged into slots of the CF or memory stick card. The plug 60 can be plugged into the USB series A receptacle 20 in FIG. 2. The plug 60 can be directly affixed onto a CF card. A receptacle on the USB cable for series A can be connected to the plug 60. The plug 60 has a second holder 64, used to hold the metal connection terminals 62. Also and, when the plug 60 is connected to the receptacle 20. At least one of the elastic plates 28 on the outer frame 26 of the receptacle 20 at the up side and each the edge side can elastically contact the outer frame 66, such as a metal frame, of the plug 60. Thickness of the second holder 64 is less than the thickness of the second holder 64 of the conventional USB series A plug 10, so as to reduce the total thickness of the plug 60. The second holder 64 can also be used just for holding the metal connection terminals 62 without need to cover the whole metal connection terminals 62 from the bottom. It can have an outer frame 66, like the metal frame 16 but thinner, to enclose the second holder 64. The bottom of the second holder 64 optionally has the outer frame 66. When the plug 60 is plugged into the receptacle 20, the outer frame 66 is inserted into the space between the first holder 24 of the receptacle 20 and the metal frame 16. The outer frame 66 contacts the metal frame 26 of the receptacle 20. At least one of the elastic plates 28 on the metal frame 26 at the up and each edge sides is elastically contacting with the outer frame 66, so as to provide the affixing effect. As a result, the second holder 64 and the metal connection terminals 62 being held can tightly contact on the first holder 24 on the receptacle 20 and the metal connection terminals 22. The elastic plates 28 on the metal frame 26 at the middle bottom may not contact the plug 60 due the reduction of thickness. One of the purposes of the second holder 64 or the metal frame 66 is to connect in contact the outer frame 26 of the receptacle 20, so as to provide an affixing function.

The metal connection terminals 62 on the second holder 64 can also be a design of elastic plates, wherein each element of the plug 60 is compatible, in specification and appearance, with the USB series A plug 10, which is used to be plugged into the receptacle 20. However, the specification and the appearance can also be modified. For example, the metal connection terminals 62 can be the exposed protruding terminals. It only needs to have a good contact between the metal connection terminals 62 of the plug 60 and the metal connection terminals 22 of the receptacle 20. It is also not the absolutely necessary for the second holder 64 to cover the whole metal connection terminals 62 from the bottom. The second holder 64 can only be used to hold the metal connection terminals 62 from a bottom. The preferred embodiment is to assure for holding and protecting the metal connection terminals 62. The thickness of the plug 60 can be (1) the thickness of the outer frame 66, (2) the thickness between the outer frame 66 and the second holder 64 (that thickness is thickness of the first holder 24 of the receptacle 20), and (3) the total thickness of the second holder 64 of the plug 60 and the metal connection terminals 62. The total thickness is less than 0.38 cm or can even down to about 0.28 cm. The plug 60 can be affixed onto the CF card. The plug 60 at each edge side has a space, where a USB cable with series A receptacle can be connected with the plug 60. The plug 60 can also be designed by a rotation arm or a retractable design, so that the plug can be directly plug into the receptacle, the outer frame 66 can be only keep the top side, and remove bottom, or other side. The log thin connector can prevent from the difficulty of insertion action due to the over large volume of the CF card. The outer frame 66 can optionally keep only the upper part in which the side and the bottom part are removed. The plug 60 can include a member for avoiding short circuit when a reverse connection is accidentally taken. This situation is that the holder for a USB standard plug in USB series A and the metal frame at the bottom side have the total thickness of about 0.2 cm. This can prevent the USB plug from be connected to the receptacle in reverse, due to the blockage by the space 26a. However, when the thickness of the metal frame is reduced, the reverse connection may occur. Then, for example, a top of the outer frame 66 of the plug 60 can have an indent space 80, The position of the indent space 80 can be matched to the expected position of the power terminal when the connection is reverse connection. In this manner, even a reverse connection is made, the power short circuit will not occur.

Alternatively, when the thickness for the second holder 64 of the plug 60 and the metal connection terminals is greater than 0.12 cm, then the reverse connection will not easily occur. A protruding structure at the end part can be designed, for example, a protruding part is included in the memory stick card, then the thickness of the memory stick is thicker than the specification of 0.28 cm, such as 0.3 cm. Since the end part with the protruding structure, the end part of the card will incapable of plugging into the slot of the memory stick card. However, the card can be plugged into the slot of memory stick card. Or, the protruding part of the plug 60 for the CF card at the side corresponding to the 50 pins of CD card can be to be 0.38 cm or even up to 0.45 cm. The protruding part of the plug 60 can prevent from reverse connection.

In the eleventh application, first referring to FIG. 4 and FIG. 6 about the conventional receptacle of USB mini A and mini B, the thickness is about 0.4 cm. The receptacle can be inserted with the plug as shown in FIG. 3 and FIG. 5.

With the same design principle, the invention introduce a receptacle with reduced thickness. The memory card, such as a CF card, is implemented with a receptacle. The thickness of the receptacle is reduced to satisfy the thickness of receptacle of USB mini A, mini B, mini AB, and then the thickness can be less than 0.4 cm or even smaller such as 0.21 cm. As a result, it can adapt the CF card by 0.33 cm, memory stick by 0.28 cm or SD card by 0.21 cm. The thickness of the slot can be varied a little. The receptacle can be directly affixed onto the SD card. A USB plug in mini type can be connected to the receptacle. The plug has a first holder to hold multiple contact terminals. When the plug is connected to the receptacle, at least one of the multiple elastic terminals on the outer frame of the receptacle can contact the outer frame of the plug, which can be a metal frame. The receptacle has the openings on top and bottom, so as to reduce the thickness, which the first holder is exposed, looking from top or bottom. Also and, the thickness of the first holder can be reduced less than the first holder 114 of the receptacle for the standard USB series mini A, mini B, or mini AB, so as to further reduce the thickness. The thickness of the receptacle is a sum of the outer frame, the distance between the outer frame and the holder, and the holder. The total thickness can be 0.38 cm or even smaller, such as 0.21 cm. The receptacle can be affixed to the CF card. A USB plug can be plugged into the receptacle.

Also and, the multiple metallic contact terminal can be designed by the elastic metal plate. Usually, in order to connect to the USB plug, the outer appearance of the receptacle is similar to the outer appearance of the plug. However, the outer appearance can also be modified. For example, the contact terminal can be a protruding contact point. It will sufficient for the structure, which allows a proper contact.

In conclusions, comparing with the conventional USB connector, the plug of the invention can effectively reduce the thickness of the plug, which can be connected to the USB plug or USB receptacle. Then, the invention allows the peripheral device of computer to be designed with better appearance and having more options, and the design principle for the master card and independent card can be used in other different type of memory cards. In the foregoing different portable memory card design, the electrical connection with the multiple metal connection terminals 62 or metal connection terminals 52 include the connection of voltage source Vcc and ground voltage GND. The number of GND connection terminals or the Vcc terminals can be reduced. The GND terminal can even be removed, and instead the frame 66 or 56 can be used as the GND connection terminal. This is because the communication distance is short.

The foregoing different designs are applied to the memory cards, which are ROM memory card. However, it can also be applied to the different type of memory card with the same principle. For example, the invention can also be applied to the conventional IEEE 1394. FIG. 19 shows the conventional IEEE 1394a connector, including the metal outer frame 190, the holder 192, and connecting pins 194. The thickness of the conventional IEEE 1394 connector can be reduced y modifying the outer frame and the holder, like the conventional USB connector.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A memory card converting device, comprising:
an I/O port A, wherein the I/O port A is connected to an I/O port B of a slot of one of different spec memory cards for connecting to an electronic device, wherein the one of the different spec memory cards include one selected from the group consisting of a CF card, a SD card, a XD picture card, a memory stick duo card, a memory stick card, a multimedia card, a MG memory stick card, a smart media card, a Microdrive card, a PCMCIA card, an ATA flash card, a SIM card, an IC card, and others memory card;
a USB-interface I/O port C, wherein the I/O port C can be coupled to a USB-interface memory card A; and
a control unit, implemented in the converting device for converting signals for the I/O port A into USB signals with respect to the I/O port C.

2. The a memory card converting device of claim 1, wherein a USB-interface memory card A with a USB interface and connect to I/O port C, wherein the memory card A together with memory card converting device has an outer appearance allowing to be inserted into one of different spec memory cards inserted slot C.

3. A connector, suitable for use in connecting to a USB “mini” type plug, the USB “mini” type plug having an outer frame and a first holder, and the first holder being implemented with metallic contact terminals, the connector comprising:
a plurality of elastic metal terminals being exposed, used to correspondingly connect to the metallic contact terminals when the plug has been inserted to the connector; and
a non-conductive second holder, used to hold the exposed elastic metal terminals; and
an outer frame protruding structure under the second holder, or an outer frame protruding structure at both sides of the second holder, wherein the USB “mini” type plug inserts between the outer frame protruding structure and the second holder.

4. A USB-interface memory card, comprising:
a connector A with a USB-interface;
a memory unit;
a control unit for data transmission; and
a structural member, used for leading the USB-interface memory card to be connected to a connector B with a USB interface installed in an electronic device,
wherein the USB-interface memory card can be connected inside the electronic device, wherein an outer appearance of the memory card can be inserted into a different memory card inserted slot A, which include a CF card, a SD card, a XD picture card, a memory stick duo card, a memory stick card, a multimedia card, a MG memory stick card, a smart media card, a Microdrive card, a PCMCIA card, an ATA flash card, a SIM card, an IC card, memory stick PRO card, or like, and the connector A connected to a different memory card inserted connector B in the slot A, and USB interface data communicates with the electronic device,
wherein, a connector C with USB-interface is optionally included, and connected to an external device USB connector for data communication.

5. The USB-interface memory card of claim 4, wherein the memory card comprises a plurality of contact terminals with respect to the USB interface, the contact terminals are at a position corresponding to an original position of contact terminals of a different spec memory card, including a CF card, a SD card, a XD picture card, a memory stick duo card, a memory stick card, a multimedia card, a MG memory stick card, a smart media card, a Microdrive card, a PCMCIA card, an ATA flash card, a SIM card, an IC card, a memory stick pro card, or other like.

6. An IEEE 1394-interface memory card, comprising:
a first connector, with a plurality of exposed contact terminals;
a structure member, for leading the IEEE 1394-interface memory card to be connected inside an electronic device for connecting to a second connector of the IEEE 1394-interface in the electronic device for the data communication; and
a connection member, for inserting into a slot, the slot adapts a memory card other than the IEEE 1394-interface memory card.

7. A plug, implemented on a CF card for connecting to a receptacle of USB series A, wherein the receptacle has an outer frame, at least four elastic terminals located at an inner side of the outer frame, and a first holder implemented with a plurality of conductive contact terminals, the plug comprising:
a plurality of conductive contact terminals, used for contacting with the conductive contact terminals of the receptacle;
a second holder, for holding the conductive contact terminals of the plug; and
an outer frame, which can be disposed inside the outer frame of the receptacle,
wherein the plug has the second holder with reduced thickness so that a thickness is less than or equal to 0.38 cm, the plug is implemented on a CF card and can be shifted out or retracted back from the CF card,
wherein the plug can be rotated or shifted out to connect to a USB connector on an electronic device.

8. The plug of claim 7, wherein the plug includes at least one protruding structure with a thickness of greater than 0.38 cm for prevent a reverse connection to the receptacle.

9. A memory card A with a USB interface, wherein the memory card A has an outer appearance allowing to be inserted into one of different spec memory card B inserted slot C, the slot C adapts a memory card B with an interface to a memory card, which other than the USB interface, the memory card A comprising:
a connector including a plurality of contact terminals for USB interface, and corresponding to a portion of contact terminals of the one of the different spec memory card B, wherein when the memory card A is inserted into the slot C, the contact terminals of the memory card A can be properly coupled to the slot C, and optionally a connector with USB interface in included for connecting to an electronic device connector for data communication .10. The memory card A of claim 9, wherein the memory card B is one selected from the group consisting of a CF card, a SD card, a XD picture card, a memory stick duo card, a memory stick card, a multimedia card, a MG memory stick card, a smart media card, a Microdrive card, a PCMCIA card, an ATA flash card, a SIM card, an IC card, and a memory stick proor other like memory cards.

10. A connection control unit, comprising:
a plurality of signal connection terminals, wherein the connection control unit is connected to a connector via the signal connection terminals, wherein the connection control unit can transmit data signals with respect to a plurality of different data signal types, and the connection control device is implemented at a USB host,
wherein the connection control unithave a detect function, and can select the USB data signal type when a USB-interface memory card is coupled to the connector,
and the connection control unit can select the signal data type other than the USB data signal type when a memory card other than the USB-interface memory card is coupled to the connector.

11. A USB-interface memory card with dual cards, comprising:
a primary memory card and a secondary memory card,
wherein the secondary memory card with a USB interface connector B can be independently connected to a USB interface device for data communication,
wherein the primary memory card can connect with a secondary memory card into a single memory card, and the single memory card with an outer appearance able to be inserted to one of the other different spec memory card inserted slot, and with a connector A in the primary memory card connect to the connector of the slot, a controller in the primary card converted the signals in connector A to a USB interface signals to connector D and connect to a connector C in the secondary memory card with the USB interface, and optionally the connector B can be the connector C,
wherein the one of the other different spec memory cardincludes a CF card, a SD card, a XD picture card, a memory stick duo card, a memory stick card, a multimedia card, a MG memory stick card, a smart media card, a Microdrive card, a PCMCIA card, an ATA flash card, a SIM card, a memory stick pro card, an IC card, or other like.

12. A receptacle, suitable for use in connection with a USB mini-type plug, the USB mini-type plug has an outer frame and a first holder with a plurality of contact terminals formed thereon, the receptacle comprising:
an exposed holder of the receptacle, includes a plurality of elastic contact terminals thereon, so as to correspondingly connect to the contact terminals of the plug; and
an outer frame with a protruding structure under the holder, or at both sides of the holder having outer frame with at least one protruding structure, the USB “mini” plug inserted between the folder and the protruding structure, which is to fix the plug and protect plug in reverse insertion, whereby a thickness of the receptacle is less than 0.34 cm.

13. A plug, used for connecting a USB series-A receptacle, the receptacle having an outer frame, at least four elastic plate on an inner side of the outer frame, and a first holder with metal contact terminals thereon, the plug comprising:
a plurality of metal contact terminals, used to correspondingly connect to the metal contact terminals of the receptacle;
a second holder, used for holding the metal contact terminals of the plug; and an outer frame, used to be inserted into the outer frame of the receptacle,
wherein the plug has the second holder with reduced thicknessso that the plug has a thickness of less equal to 0.38 cm, wherein the plug can optionally have at least one portion with a thickness greater than 0.38 cm for preventing a reveres connection from occurring.

14. A variable memory card and slot connection structure, comprising
a slot with at least one set of connection terminals at a position, or a set with at least two sets of connection terminals at a different position,
wherein the one or two sets of connection terminals does not against at least two different length memory card insert to the slot, two different length memory card have about the same width and thickness and each with one connector, and connected to one set of connection terminal in the slot, optionally the two sets of connection terminals with the same interface signals, optionally the connection terminals with same interface signals and at least two sets of connection terminals by a plug can be connect together.

15. The connection structure of claim 14, further comprising a connecting protection structure for preventing shorter length memory card over deep inserted wherein the connecting protection structure includes a protruding structure.

16. A memory card, comprising:
at least 25 exposed connection terminals put at one side, and with interface signals as part of CF or PCMCIA card interface signals, including VCC, Gnd, 11 address signals and at least 8 data signals and read and write control signals, wherein the memory card size is less than a CF card, the card can optionally with an outer look, which is close to one of different types of a memory card, so that it is able to insert to one of SD or MS or MS PRO or XD or other memory card slot, and connect to a connector with at least 25 CF interface connection terminals in the slot.

17. A transfer controller, comprising:
a functional circuit to reduce the memory card interface signals number,
wherein the controller compresses at least two of CF card interface signals to one compressed CF interface signal for reducing the memory interface signals number need for a memory card interface, then reduce the connection terminals number in a memory card. wherein with respect to CF signals, optionally the transfer controller can use a higher speed one to transmit compressed CF interface signals.

18. The transfer controller of claim 17, wherein the transfer controller is installed in a memory card, and optionally integrated with the controller chip inside, or the transfer controller is installed in an electronic device.

19. A transfer controller, comprising:
a functional circuit, for transferring from one type of memory card interface signal A to another interface signal B, wherein interface signals B includes two types of memory card interface signals, then transfer controller can communication with two memory cards, which with two different interface signals, wherein the transfer controller with a detecting function, to detect which type of memory card connected, and select one of the two interface signals for communication.

20. The transfer controller of claim 19, wherein the transfer controller is installed in a memory card, and optionally integrated with the controller chip inside, or the transfer controller is installed in an electronic device.
